(19) United States
(12) Patent Application Publication
(10) Pub. No.: US 2019/0032903 A1
(43) Pub. Date: Jan. 31, 2019

(54) LED MODULE STRUCTURE FREE OF LOCKING WITH SCREWS

(71) Applicant: Dongguan Jiasheng Lighting Technology Co., Ltd., Dongguan City (CN)

(72) Inventor: Shuisheng XU, Dongguan City (CN)

(21) Appl. No.: 16/049,967

(22) Filed: Jul. 31, 2018

(30) Foreign Application Priority Data
Jul. 31, 2017 (CN) 201720946285.7

(51) Int. Cl. F21V 21/088; F21V 17/18; F21S 8/04

(52) U.S. Cl. CPC F21V 21/088; F21Y 2115/10; F21S 8/04; F21V 17/18

(57) ABSTRACT

An LED module structure free of locking with screws comprises a ceiling plate and an LED module detachably mounted to the bottom of the ceiling plate; a plurality of clamping pieces and a plurality of releasing pieces are arranged in the middle of the bottom end of the ceiling plate; the plurality of clamping pieces define a clamping structure; the releasing pieces are arranged between every two adjacent clamping pieces; the LED module is clamped inside the clamping structure and limited to one side of the releasing pieces; the LED module comprises an LED substrate and a lampshade; the LED substrate is provided with a plurality of mounting holes; a bottom plate is arranged on the lampshade, and a plurality of bulges are arranged on the top surface of the bottom plate, and clamped into the mounting holes in the LED substrate.

### FIELD OF THE INVENTION

The invention relates to the technical field of illumination, and more particularly to an LED module free of locking with screws.

### BACKGROUND OF THE INVENTION

At present, an LED ceiling lamp on the market comprises a lampshade, a ceiling plate and an aluminum substrate provided with an LED light source, wherein the lampshade and a bottom plate are fixedly screwed with screws generally when they are connected, and the aluminum substrate is also fixed to the ceiling plate with screws, such that a screwdriver must be needed during assembly and disassembly, thereby bringing inconvenience in operation, consuming much time and greatly affecting the production efficiency and the maintenance efficiency.

### SUMMARY OF THE INVENTION

Therefore, an objective of the invention is to provide an LED module structure free of locking with screws, so as to solve the problem that the ceiling lamp is inconvenient to disassemble ad assemble at present.

To achieve the objective, the present invention mainly adopts the following technical solutions.

An LED module structure free of locking with screws comprises a ceiling plate and an LED module detachably mounted to the bottom of the ceiling plate; a plurality of clamping pieces and a plurality of releasing pieces are arranged in the middle of the bottom end of the ceiling plate; the plurality of clamping pieces define a clamping structure; the releasing pieces are arranged between every two adjacent clamping pieces; the LED module is clamped inside the clamping structure and limited to one side of the releasing pieces; the LED module comprises an LED substrate and a lampshade; the LED substrate is provided with a plurality of mounting holes; a bottom plate is arranged on the lampshade, and a plurality of bulges are arranged on the top surface of the bottom plate, and clamped into the mounting holes in the LED substrate.

Further, each clamping piece is L-shaped and comprises a vertical connecting part and a transverse limiting part; the limiting parts of the plurality of clamping pieces extend towards a center direction of the ceiling plate.

Further, the LED module is set as a corresponding polygonal structure according to the number of the clamping pieces, and exterior angles of the polygon are in one-to-one correspondence to the plurality of clamping pieces.

Further, the LED substrate and the bottom plate of the lampshade are of a polygonal structure respectively, and the LED substrate and the lampshade are arranged in an up-down alignment manner.

Further, a side length of the LED substrate and a side length of the bottom plate of the lampshade are respectively smaller than a distance between the tail ends of the limiting parts of two opposite clamping pieces.

Further, a length of a diagonal line of the bottom plate is larger than the distance between the tail ends of the limiting parts of two opposite clamping pieces and smaller than a distance between connecting parts of two opposite clamping pieces.

Further, the ceiling plate is further provided with a fool-proof point, and the LED substrate is correspondingly provided with a fool-proof opening.

Further, a ground wire screw which is the fool-proof point or one of the limiting pieces is also arranged on the ceiling plate.

From the above, according to the LED module structure disclosed by the invention, the lampshade is mounted on the LED substrate in a clamping manner, and then the lampshade and the LED substrate are synchronously mounted to the ceiling plate in a clamping manner. Therefore, the lampshade, the substrate and the ceiling plate are fixedly mounted without locking with screws; the dismounting and mounting are simple, convenient and stable; meanwhile, locking materials, such as a large number of screws are also saved. The LED module structure disclosed by the invention has the advantages of strong practicability and great significance in promotion.

### BRIEF DESCRIPTION OF THE DRAWINGS

FIG. 1 is a cross-sectional schematic drawing of an embodiment of an LED module structure free of locking with screws according to the invention;

FIG. 2 is an exploded schematic drawing of the LED module structure free of locking with screws in FIG. 1;

FIG. 3 is a front schematic drawing of a ceiling plate in FIG. 2;

FIG. 4 is a structural schematic drawing of an LED substrate in FIG. 2;

FIG. 5 is a structural schematic drawing of a lampshade in FIG. 2; and

FIG. 6 is a structural schematic drawing of a mounting jig.

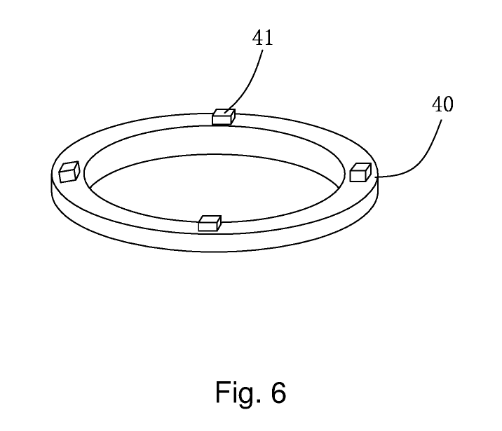

### DETAILED DESCRIPTION OF THE PREFERRED EMBODIMENTS

The invention will be described in further detail with reference to the accompanying drawings and the accompanying drawings, in order to make the purpose, the technical solutions and the advantages of the invention understood more clearly.

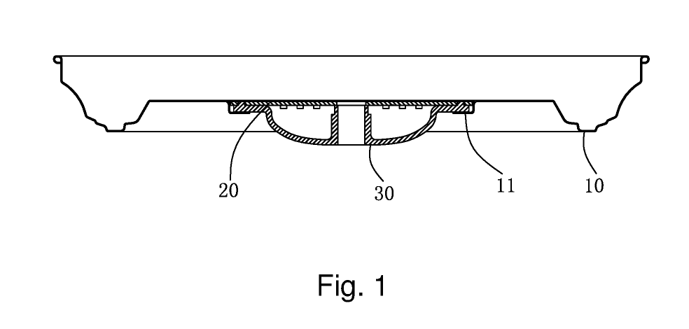

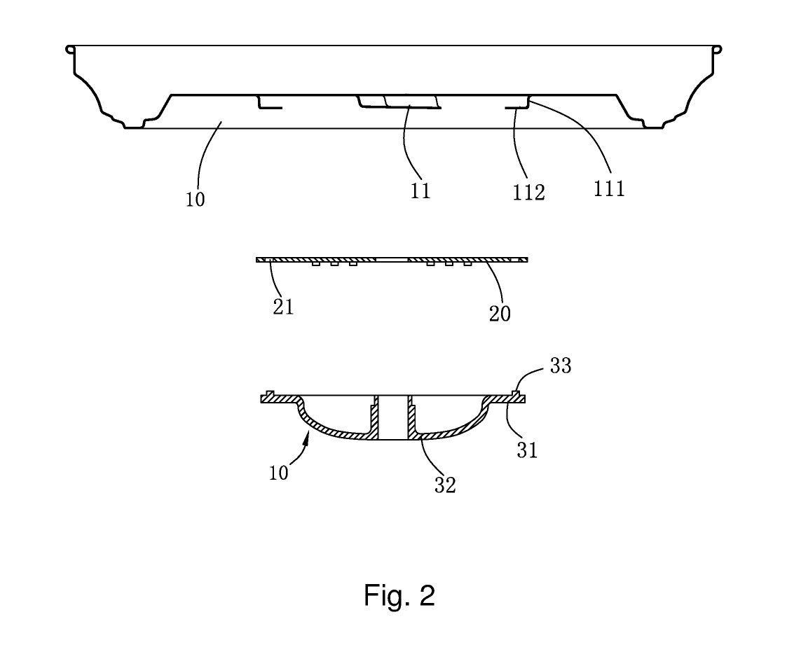

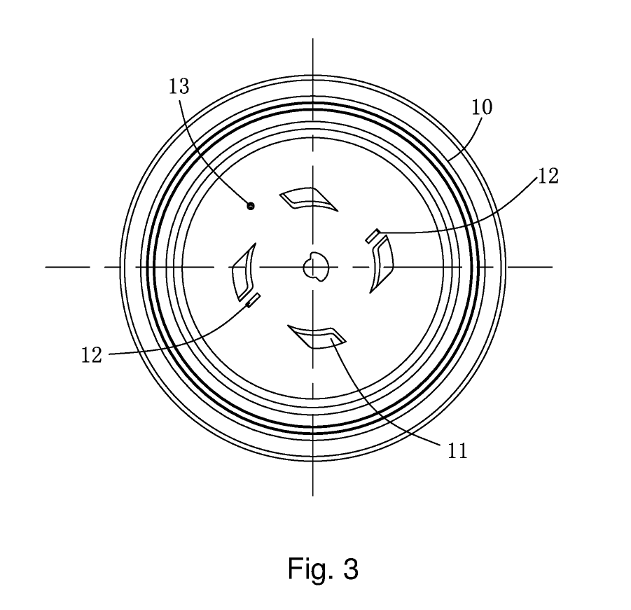

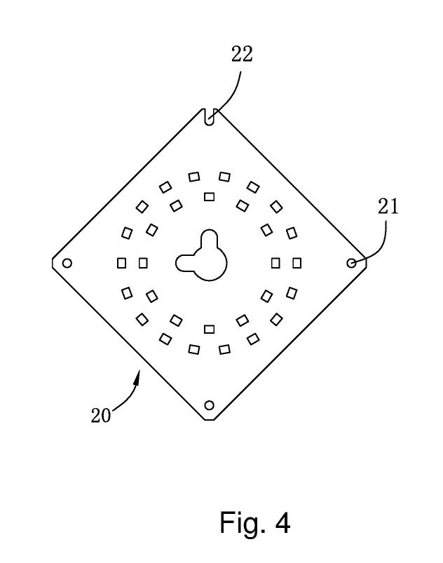

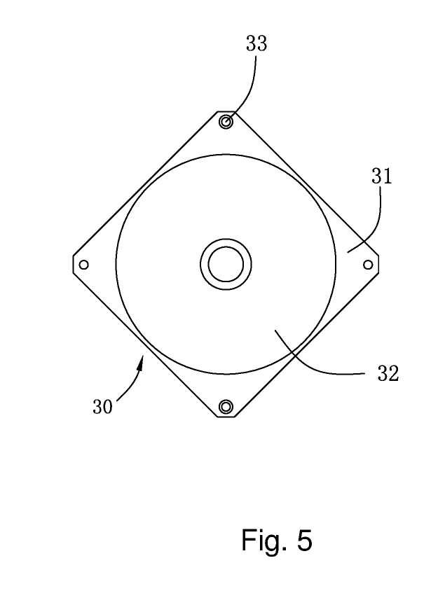

As shown in FIGS. 1 to 5, the invention provides an LED module structure free of locking with screws. The LED module structure free of locking with screws comprises a ceiling plate 10 and an LED module detachably mounted to the bottom of the ceiling plate. The LED module comprises an LED substrate 20 and a lampshade 30. The lampshade 30 is clamped to the bottom of the LED substrate 20, and the lampshade 30 and the LED substrate 20 are respectively clamped to the bottom of the ceiling plate 10.

A plurality of clamping pieces 11 is arranged in the middle of the bottom end of the ceiling plate 10. The plurality of clamping pieces 11 enclose each other to form a clamping structure; the LED module is clamped into the clamping structure; the LED module is set as a corresponding polygonal structure in conjunction with the number of the clamping pieces 11. In the present embodiment, there are four clamping pieces 11, and the four clamping pieces 11 are uniformly distributed on the ceiling plate 10. Each clamping piece 11 is L-shaped and comprises a vertical connecting part 111 and a transverse limiting part 112. The limiting parts 112 of the plurality of clamping pieces 11 extend respectively towards a center direction of the ceiling plate 10. An inside surface of each connecting part 111 is arc-shaped. Two retaining pieces 12 are also arranged on the ceiling plate 10, are disposed oppositely and are arranged between every two adjacent clamping pieces 11 respectively. In addition, the ceiling plate 10 is further provided with a fool-proof point 13. In the invention, the fool-proof point 13 is a position where a ground wire screw is mounted. In addition, the ground wire screw may further be arranged between the two clamping pieces 11 and used for substituting one of the limiting pieces 12.

In the invention, the LED substrate 20 is quadrilateral. It may be understood that the LED substrate 20 may also be set as other shapes in other embodiments. Three of the corner positions of the LED substrate 20 are respectively provided with a mounting hole 21, and the remaining corner position is provided with a fool-proof opening 22; the fool-proof opening 22 corresponds to the fool-proof point 13 on the ceiling plate 10. It may be understood that the mounting hole 21 may also be formed in any other position of the LED substrate 20. The lampshade 30 comprises a bottom plate 31 and a raised part 32 arranged on the bottom surface of the bottom plate 31, and the bottom plate 31 is quadrilateral. The raised part 32 is arranged in the middle of the bottom plate 31, the top surface of the bottom plate 31 is provided with a plurality of bulges 33, and the bulges 33 are in one-to-one correspondence to the mounting holes 21 in the LED substrate 20.

A side length of the LED substrate 20 and a side length of the bottom plate 31 of the lampshade 30 are respectively smaller than a distance between the tail ends of the limiting parts 112 of the two opposite clamping pieces 11, such that the LED substrate and the lampshade 30 may be clamped into the clamping structure smoothly. A length of a diagonal line of the bottom plate 31 or the bottom 31 and the LED substrate 20 is larger than the distance between the tail ends of the limiting parts 112 of two opposite clamping pieces 11, and smaller than a distance between connecting parts 111 of two opposite clamping pieces 11. Therefore, the LED substrate 20 and the lampshade 30 may be rotatably clamped and limited into the clamping pieces 11.

The LED module structure free of locking with screws further has a mounting jig 40. Four clamping blocks 41 are arranged on the bottom surface of the mounting jig 40. The four clamping blocks 41 defines a quadrangle, and inside surfaces of the two clamping blocks 41 which are arranged diagonally are parallel. A distance between the inside surfaces of the two opposite clamping blocks 41 is equal to a side length of the LED substrate 20 and a side length of the bottom plate 31 of the lampshade, or equal to a length of a larger side of the LED substrate 20 and the bottom plate 31 of the lampshade.

During mounting, the bulges 33 on the lampshade 30 are clamped into the mounting holes 21 in the LED substrate 20, such that the lampshade 30 and the LED substrate 20 form a whole; and corners and sides of the combined lampshade 31 and LED substrate 20 are aligned to each other; then, the combined lampshade 30 and LED substrate 20 are mounted into the clamping structure; later, the four clamping blocks 41 of the mounting jig 40 are clamped to the outer sides of four sides of the bottom plate 31 and the LED substrate 20; and finally, the mounting jig 40 is rotated to drive the LED substrate 20 and the lampshade 30 to rotate till the LED substrate 20 and the lampshade 30 are rotated to one side of the retaining pieces 12; at this moment, the fool-proof opening 22 corresponds to the fool-proof point 13.

According to the LED module structure disclosed by the invention, the lampshade is mounted on the LED substrate in a clamping manner, and then the lampshade and the LED substrate are synchronously mounted to the ceiling plate in a clamping manner. Therefore, the lampshade, the substrate and the ceiling plate are fixedly mounted without locking with screws; the dismounting and mounting are simple, convenient and stable; meanwhile, locking materials, such as a large number of screws are also saved. The LED module structure disclosed by the invention has the advantages of strong practicability and great significance in promotion.

The above embodiment is only a preferred embodiment of the invention and is not intended to limit the invention. Any amendments, equivalent replacements, improvements and the like made within the spirit and principle of the invention should fall into the protection scope of the invention.

What is claimed is:

1. An LED module structure free of locking with screws, comprising a ceiling plate and an LED module detachably mounted to the bottom of the ceiling plate, wherein a plurality of clamping pieces and a plurality of releasing pieces are arranged in the middle of the bottom end of the ceiling plate; the plurality of clamping pieces define a clamping structure; the releasing pieces are arranged between every two adjacent clamping pieces; the LED module is clamped inside the clamping structure and limited to one side of the releasing pieces; the LED module comprises an LED substrate and a lampshade; the LED substrate is provided with a plurality of mounting holes; a bottom plate is arranged on the lampshade, and a plurality of bulges is arranged on the top surface of the bottom plate, and clamped into the mounting holes in the LED substrate.

2. The LED module structure free of locking with screws according to claim 1, wherein each clamping piece is L-shaped and comprises a vertical connecting part and a transverse limiting part; the limiting parts of the plurality of clamping pieces extend towards a center direction of the ceiling plate.

3. The LED module structure free of locking with screws according to claim 1, wherein the LED module is set as a corresponding polygonal structure according to the number of the clamping pieces, and exterior angles of the polygon are in one-to-one correspondence to the plurality of clamping pieces.

4. The LED module structure free of locking with screws according to claim 3, wherein the substrate and the bottom plate of the lampshade are of a polygonal structure respectively, and the LED substrate and the lampshade are arranged in an up-down alignment manner.

5. The LED module structure free of locking with screws according to claim 4, wherein a side length of the LED substrate and a side length of the bottom plate of the lampshade are respectively smaller than a distance between the tail ends of the limiting parts of two opposite clamping pieces.

6. The LED module structure free of locking with screws according to claim 5, wherein a length of a diagonal line of the bottom plate is larger than the distance between the tail ends of the limiting parts of two opposite clamping pieces and smaller than a distance between connecting parts of two opposite clamping pieces.

7. The LED module structure free of locking with screws according to claim 1, wherein the ceiling plate is further provided with a fool-proof point, and the LED substrate is correspondingly provided with a fool-proof opening.

8. The LED module structure free of locking with screws according to claim 7, wherein a ground wire screw which is the fool-proof point or one of the limiting pieces is also arranged on the ceiling plate.
